(19) United States
(12) Patent Application Publication
(10) Pub. No.: US 2006/0040744 A1
(43) Pub. Date: Feb. 23, 2006

(54) Device for accessing an environment for multi-user interaction

(75) Inventor: Asko Lauri Antero Vetelainen, Jaali (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/925,176

(22) Filed: Aug. 23, 2004

(51) Int. Cl. A63F 9/24; G06F 17/30

(52) U.S. Cl. 463/42; 707/1

(57) ABSTRACT

A device for accessing an environment for multi-user interaction, comprising: a receiver for receiving an identifier associated with a first user when the first user enters the environment; a controller for checking the received identifier against a database including a plurality of different identifiers; and means for providing an alert to a user of the device if the received identifier corresponds to an identifier included in the database.

### FIELD OF THE INVENTION

Embodiments of the present invention relate to a device for accessing an environment for multi-user interaction.

### BACKGROUND TO THE INVENTION

Devices such as computers, mobile radio telephones and personal digital assistants can connect to servers to access environments for multi-user interaction. An environment for multi-user interaction may be any environment that allows at least two users, using separate devices, to interact and communicate with one another. An environment for multi-user interaction may be provided through the internet and consequently, it may be an on-line session of many different types. A software application, stored on and executed by a server, may provide an environment for multi-user interaction for those users who are connected to the server. Examples of software applications that provide environments for multi-user interaction include multi-player computer games and chat rooms.

When there are a large number of users accessing the environment for multi-user interaction, it may be difficult for any one of the users to identify when a new user has entered the environment. Currently, a new user is identified to each user of the environment by textual information. For example, when a new user enters the environment, the display of each device may display “A new user has joined”.

One disadvantage associated with the above identification of a new user is that the alert (the display of textual information) may be overlooked by users who may not notice that a user in whom they are interested, has entered the environment. Alternatively, a user may be distracted by the announcement of a new user in whom they are not interested. This may be a problem when the users already accessing the environment are focusing their attention on the environment, for example concentrating on playing a game.

It is desirable to provide an alternative way of alerting a user of a device to the entry of a new user to the environment for multi-user interaction.

### BRIEF DESCRIPTION OF THE INVENTION

According to one embodiment of the invention there is provided a device for accessing an environment for multi-user interaction, comprising: a receiver for receiving an identifier associated with a first user when the first user enters the environment; a controller for checking the received identifier against a database including a plurality of different identifiers; and means for providing an alert to a user of the device if the received identifier corresponds to an identifier included in the database.

The means for providing an alert may not provide an alert to the user if the received identifier does not correspond to an identifier included in the database.

The means for providing an alert may provide a second alert, different to the alert, if the received identifier does not correspond to an identifier included in the database. The database may include a first portion of data for each of the plurality of different identifiers and a second portion of data for at least one of the plurality of different identifiers, whereby the controller checks the first portion of data in response to an identifier. The controller may check for the presence of the second portion of data in the database and if the second portion of data is present, the controller may request the means for providing an alert, to provide an alert derived from the second portion of data.

The controller may check for the presence of the second portion of data in the database and if the second portion of data is not present, the controller may provide a second alert derived from at least a part of the first portion of data. The second alert may be derived by audio synthesis.

The first portion of data may comprise a user's name and ID data unique to the first user. The first portion of data may alternatively comprise a telephone number associated with the first user. The second portion of data may comprise voice data, image data, video data or other kind of multimedia presentation data.

The means for providing an alert may be an audio output device. The alert may be an audio alert from the audio output device. The alert may be a reproduction of voice data from the audio output device.

The device may be operable to access a server which controls the environment for multi-user interaction. The device may be operable to access a server which controls a second environment for multi-user interaction, wherein a further database, associated with the second environment for multi-user interaction, is stored on the server that controls the second environment for multi-user interaction. The device may have any of the features set out above, for use when a new user enters the second environment.

The environment for multi-user interaction may be a software application. The environment for multi-user interaction may be a chat room. The environment for multi-user interaction may be a computer game.

The device may be a portable handheld radiotelephone. The device may be a mobile game console.

According to another embodiment of the invention there is provided a method for identifying when a first user enters an environment for multi-user interaction, comprising: receiving an identifier associated with the first user; checking the received identifier against a database including a plurality of different identifiers; and providing an alert to a user if the received identifier corresponds to an identifier included in the database.

According to a further embodiment of the invention there is provided a program for a computer comprising: means for determining that an identifier associated with the first user has been received; means for checking the received identifier against a database including a plurality of different identifiers; and means for requesting an alert to be provided to a user of the computer if the received identifier corresponds to an identifier included in the database.

According to anther embodiment of the invention there is provided a database, associated with an environment for multi-user interaction, for storing information corresponding to at least one user, the information including a plurality of different identifiers for respective users and voice data associated with at least one user.

According to a further embodiment of the invention there is provided a graphical user interface for displaying: a database, associated with an environment for multi-user interaction, for storing information corresponding to at least one user, the information including a plurality of different identifiers for different users and voice data associated with at least one user, wherein the graphical user interface is responsive to an input from a user to modify the identifier or voice data associated with a user.

According to another embodiment of the invention there is provided a program for a computer for providing a graphical user interface as described in the preceding paragraph.

According to a further embodiment of the invention there is provided a data carrier storing a program for a computer as described in the preceding paragraphs.

### BRIEF DESCRIPTION OF THE DRAWINGS

For a better understanding of the present invention reference will now be made by way of example only to the accompanying drawings in which:

FIG. 1 illustrates a schematic diagram of a first embodiment of the present invention;

FIG. 2 illustrates a schematic diagram of a memory;

FIG. 3 illustrates a flow diagram of one embodiment of the present invention;

FIG. 4 illustrates a schematic diagram of a second embodiment of the present invention; and

FIG. 5 illustrates a schematic diagram of one embodiment of a device displaying a graphical user interface.

### DETAILED DESCRIPTION OF EMBODIMENTS OF THE INVENTION

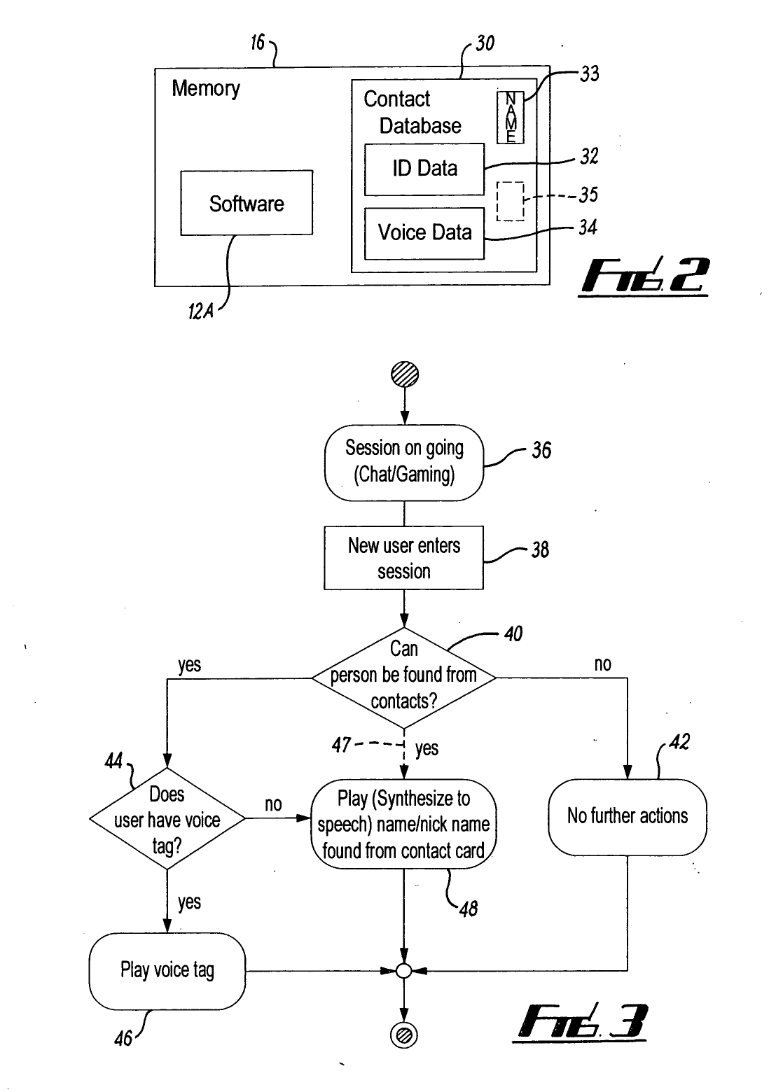

The Figures illustrate a device 10 for accessing an environment for multi-user interaction, comprising: a receiver 24 for receiving an identifier associated with a first user when the first user enters the environment; a controller 12 for checking the received identifier against a database 30 (FIG. 2) including a plurality of different identifiers 32, 34; and means 20 for providing an alert to a user of the device if the received identifier corresponds to an identifier included in the database.

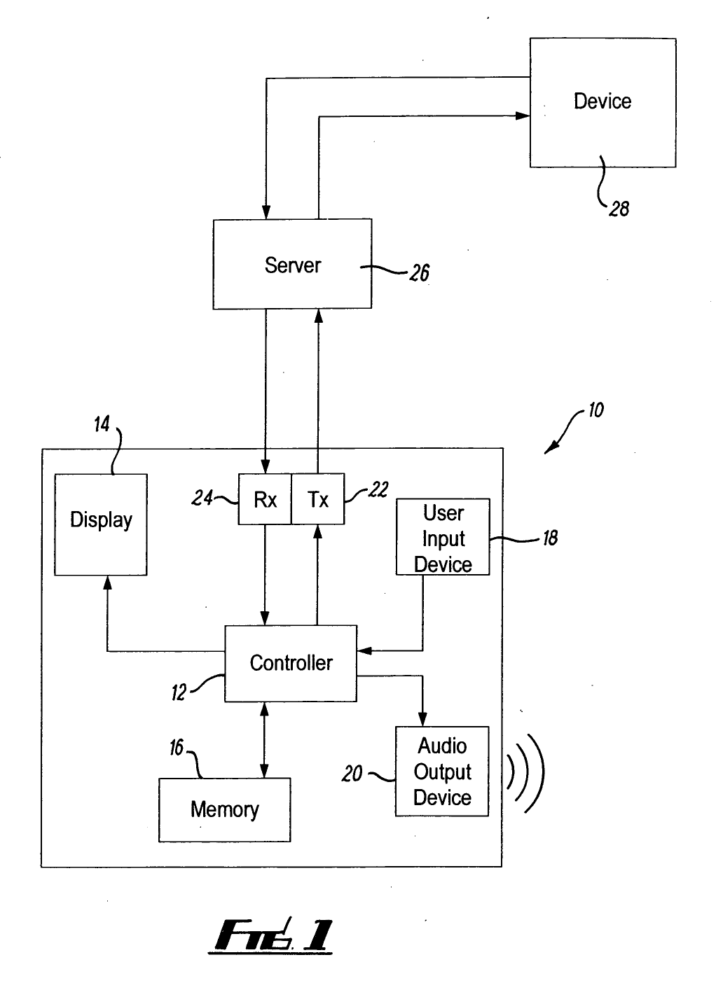

In more detail, FIG. 1 illustrates a schematic diagram of a device 10 for accessing an environment for multi-user interaction according to a first embodiment of the present invention. The device 10 includes a controller 12, a display 14, a memory 16, a user-input device 18 and an audio output device 20.

The device 10 is any suitable electronic device that may access an environment for multi-user interaction. The device 10 may be a mobile cellular radio telephone, mobile game console, a personal digital assistant, a personal computer or a console. The device 10 illustrated is a mobile cellular telephone and further comprises a cellular radio transmitter 22 and a cellular radio receiver 24.

The controller 12 is a processor device operating under the control of suitable software 12A to effect the operations described below.

The display 14 is coupled to the controller 12 for receiving and displaying data associated with the environment for multi-user interaction. The display 14, in this embodiment, displays a graphical user interface (GUI) which may allow a user to access the environment for multi-user interaction and allows him to edit data stored in the memory 16 or data stored at a server. The display 14 may be integral with the device 10 or may be an external component, coupled to the controller 12 of the device 10 via a physical link (for example, electrical wiring or cabling) or via a wireless link (for example, a low power radio frequency link such as Bluetooth). The display 14 may be any suitable display capable of displaying data associated with the environment with multi-user interaction and may be in particular a liquid crystal display (LCD), a thin film transistor display (TNT), a monitor or a television. The controller 12 is electrically coupled to control the display 14 and read to and write from the memory 16. The memory 16 may store, among other things, audio data files and image data files. The memory 16 may be any suitable memory and may, for example be built-in permanent memory such as flash memory or it may be a removable memory such as a hard disk, secured digital (SD) card, a micro drive or an MMC memory card.

The controller 12 is electrically coupled to the user input device 18 from which it receives commands signals. The user input device 18 may be any suitable user input device and may, for example be a keyboard, keypad, mouse, stylus or track ball. In the illustrated example, the user input device 18 is an integral component of the device 10. However, in other implementations it may be separate and remote, and connectable to the controller 12 via a wireless link such as a low power radio frequency link.

The controller 12 is electrically coupled to the audio output device 20 to provide an audio output from the device 10. Consequently, the audio output device 20 may act as a means for providing an alert to a user of the device 10. The audio output device 20 may be, for example, an audio speaker.

The controller 12 is electrically coupled to a transmitter 22 and a receiver 24 to respectively transmit and receive data from a server 26. The connection to the server 26 may be direct, as shown, or indirect, via a cellular telephone network, for example. The server 26 controls an environment for multi-user interaction, which may be for example, a chat room or a computer game. The server 26 is connected to a further device 28 of another user. The device 28 has substantially the same structure and functionality as the device 10. The device 28 is also connected to the server 26 to access the environment for multi-user interaction. Since the device 10 and the device 28 may both connect to the server 26 to access the environment for multi-user interaction, they are effectively connected to one another via the server 26. Consequently, the device 10 and the device 28 may communicate or interact with one another.

The server 26 may be provided by appropriate software running on appropriate hardware, which may be the controller 12, in which case, the device 10 will perform the functions of client and server.

FIG. 2 illustrates a detailed schematic diagram of the memory 16. The memory 16 is coupled to the controller 12 and includes a database 30 of entries which each include a first portion of data 32 and a second portion of data 34. In this embodiment, the database 30 is a contact database. In this embodiment, the first portion of data includes ID data 32 and name data 33 and the second portion of data comprises voice data 34. In other embodiments, the first portion of data comprises a telephone number 35 associated with the first user and/or the second portion of data may additionally or alternatively comprise image data, or other data associated with a user. For example, the second portion of data may comprise location, age or sex data associated with the first user.

The contact database 30 is associated with the environment for multi-user interaction and is operable to store information corresponding to at least one user, which, in this example, is assumed to be the user of the device 28. Consequently, at least a portion of the ID data 32, the name data 33 and the voice data 34 is associated with the user of the device 28.

The user of the device 10 may provide command instructions to the user input device 18 to control the GUI displayed on the display 14 to edit the contact database 30. This may include modifying, deleting or replacing any one of the ID data 32, the name data 33 or the voice data 34.

The contact database 30 and the first and second portions of data may be stored in the device memory 16 or on the server 26. For example, the contact database 30 may be stored in the device memory 16, but the second portion of data including the voice data 34 may be stored at the server. This is advantageous if the device 10 has a small memory space because voice data may require a large memory space. Additionally, it may allow the users' of other devices to edit the voice data contained in the contact database. This may provide a higher level of personalisation for the voice data. Alternatively, the contact database 30 may be stored on the server 26 and the second portion of data including the voice data 34 may be stored on the device 10. This is advantageous if it is desired that the user of the device 10 only has access to the contact database 30 when they are connected to the server 26. The device memory 16 may be removable from the device 10, such as an MMC memory card.

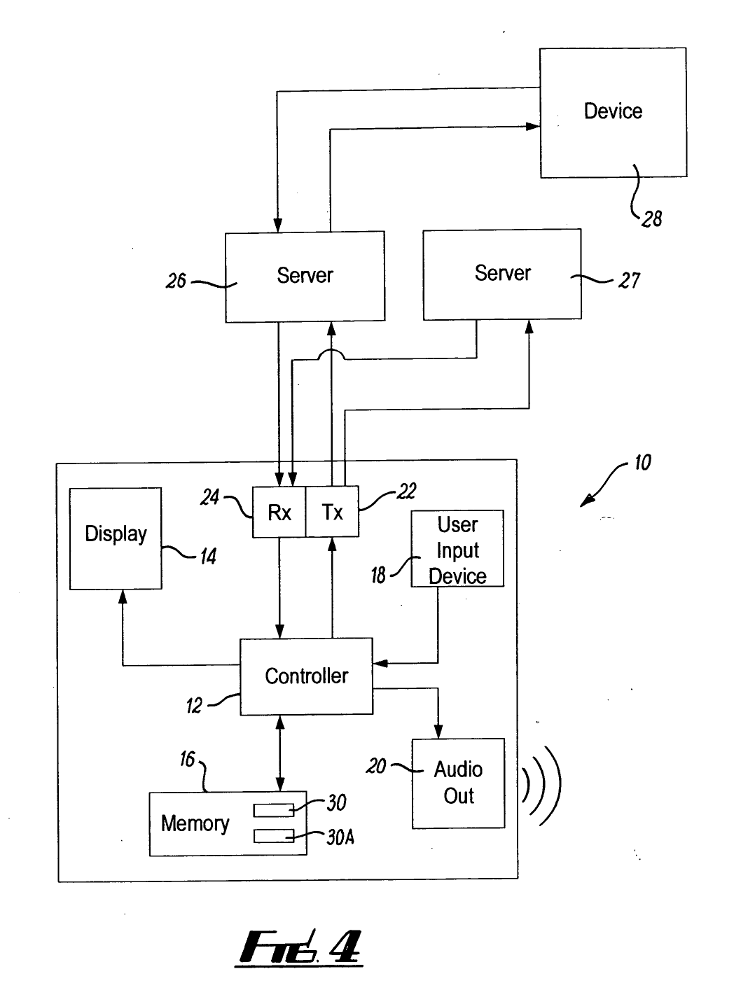

The operation of a new user entering an environment for multi-user interaction will now be explained with reference to FIGS. 1, 2 and 3.

At step 36, the device 10 is connected to the server 26 and has access to an environment for multi-user interaction. When a new user, operating the device 28, wants access to the environment for multi-user interaction, the device 28, sends a message to the server 26 requesting access to the environment for multi-user interaction. At step 38, if the server 26 grants access to the environment, the device 28 has access to the environment.

Once the device 28 has been granted access to enter the environment, the server 26 transmits an identifier associated with the first user of the device 28 to each other device which is accessing the environment, including the device 10. The identifier is received by the receiver 24 and is provided to the controller 12 which performs a determination as to whether an identifier has been received. Once it has been determined that an identifier has been received, at step 40 the server 26 checks the contact database 30 for a corresponding identifier. In this example, the identifier transmitted by the server 26 to the device 10 includes ID data unique to the user of the device 28.

The controller 12 checks the contact database 30 for ID data 32 corresponding to the ID data in the received identifier. At step 42, if no ID data 32 in the contact database 30 corresponds to the ID data in the received identifier, no alert is provided to the user of the device 10 for the entry of the user of the device 28 to the environment for multi-user interaction. This corresponds with the new user being previously unknown to the user of the device 10, or not being of interest.

If the controller 12 finds ID data 32 corresponding to the ID data of the received identifier, this corresponds with the new user being previously known to and of interest to the user of the device 10. The controller 12 at step 44, checks for the presence of voice data 34 in the contact database 30. If voice data 34, corresponding to the user of the device 28 is present, the controller controls the audio output device to provide a reproduction of the voice data to the user of the device 10. The reproduction of the voice data, in this example, may comprise the name of the user of the device 28. The voice data may be an audio file recorded previously by the user identified by the identifier. In alternative embodiments, the second portion of data may comprise image data and the display 14 displays an alert in the form of an image, which may be an image of the user of the device 28, instead of providing a reproduction of voice data. The second portion of data may comprise video data or other data for multimedia presentation.

If voice data 34 corresponding to the user of the device 28 is not present in the contact database 30, the controller, in this embodiment at step 48, processes the name data 33 into audio synthesised name data and transmits it to the audio output device 20 to provide an audio alert to the user of the device 10. It should be appreciated that in alternative embodiments, the user of the device 10 may be alerted to the entry of the user of the device 28 to the environment by textual information or by some other means. In a simpler alternative embodiment, a second portion of data, such as voice data 34, is not held in the database for any of the users. Thus, any user recognised as described, gives rise to a synthesised alert.

Since a check is done by the controller 12 to ascertain whether the contact database 30 contains ID data 32 for the user of the device 28, the alert is conditional upon the user of the device 10 having an entry in the contact database 30 for the user of the device 28. An advantage associated with this is that the user of the device 10 is not alerted to the entry of a user to the environment that he does not know, or whose presence in the environment is not of interest. In each of the examples, the alert identifies the new user (by being unique), in addition to indicating that a new user has entered.

A further advantage provided by embodiments of the present invention is that the user is provided with an audio alert identifying the new user who has entered the environment for multi-user interaction, such as by name. An audio alert is more likely, than textual information, to attract the attention of a user who is concentrating on the environment. Additionally, since in some embodiments the audio alert comprises voice data containing the users' name, the user of the device 10 is informed of who has entered the environment.

In an alternative embodiment, the user of the device 10 may not want to be alerted to the entry of a new user to the environment by a reproduction of stored voice data. Instead, the user may wish to be alerted by audio synthesised name data. In this alternative, if the controller 12 finds ID data 32 corresponding to the ID data of the received identifier, the controller 12 processes the name data 33 into audio synthesised name data and transmits it to the audio output device 20 to provide an alert to the user of the device 10 (step 48). This step is indicated by the dotted arrow 47 which provides an alternative “YES” response to step 40 to the one set out in the preceding paragraphs. The user may be provided with an option, selectable through the GUI to be described, allowing the user to choose whether the “YES” response to step 40 results in the unconditional execution of step 48, or whether execution of step 48 is conditional on the determination made at step 44.

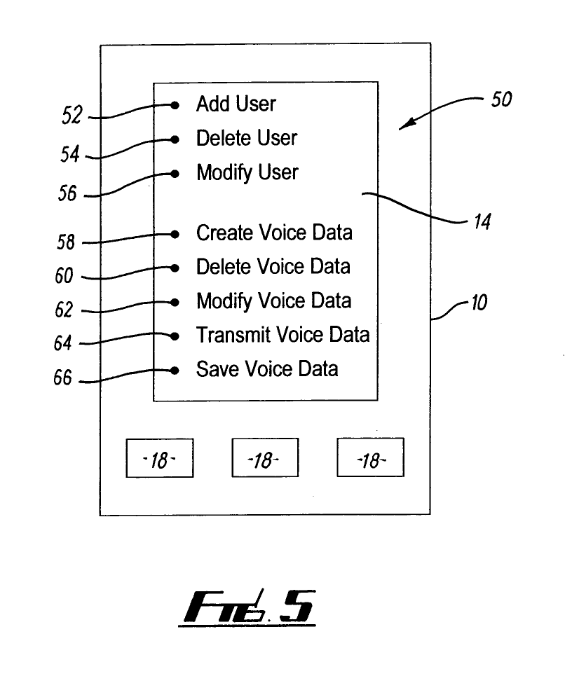

FIG. 4 illustrates a second embodiment of a device accessing an environment for multi-user interaction. Where the features of FIG. 4 are similar to the features of FIG. 1, the same reference numerals have been used.

As illustrated in FIG. 4, the device 10 has access to a first environment for multi-user interaction via the server 26 and a second environment for multi-user interaction via a server 27. In this example, the first environment for multi-user interaction is a computer game and the second environment for multi-user interaction is a chat room. The memory 16 of the device 10 comprises a first contact database 30 for the computer game and a second contact database for the chat room 30A.

In this example, the controller 12 checks the first contact database and the second contact database for ID data corresponding to a user of the device 28. If the user of the device 28 does not have ID data in one of the contact databases (such as the database 30 relating to the computer game) but does have ID data in the other database (such as the database 30A relating to the chat room), ID data will be found in the second contact database 30A relating to the chat room, but not in the contact database 30 relating to the computer game. The data can then be used as described above, to provide an alert which identifies the new user. As illustrated in FIG. 4, the controller 12 checks the second contact database 30A relating to the chat room even though the device 28 is not requesting access to the chat room via the server 27.

One advantage provided by this embodiment of the invention, is that multiple contact databases may be searched for ID data relating to a device entering any of the environments to which the device has access. This provides a greater probability that corresponding ID data will be found for the new user.

FIG. 5 illustrates a graphical user interface (GUI) 50 by means of which the user may control operation of the device 10. The GUI 50 provides a menu on the display 14. Menu options may be selected by use of the user input device 18. The GUI includes at least the following menu options:

(a) options 52, 54, 56 for, respectively, adding, deleting or modifying data relating to another user to, from or in the database 30;

(b) options 58, 60, 62 for, respectively, creating, deleting or modifying voice data relating to the user of the device 10, for provision to other users for use as has been described; and

(c) option 64 for transmitting voice data created at 58 or modified at 62, to another user or server. (d) option 66 for saving voice data created at 58 or received from another user or server.

Although embodiments of the present invention have been described in the preceding paragraphs with reference to various examples, it should be appreciated that modifications to the examples given can be made without departing from the scope of the invention as claimed.

Although embodiments of the present invention have been described in the preceding paragraphs with reference to various examples, it should be appreciated that modifications to the examples given can be made without departing from the spirit and scope of the invention.

I claim:

1. A device for accessing an environment for multi-user interaction, comprising:
a receiver for receiving an identifier associated with a first user when the first user enters the environment;
a controller for checking the received identifier against a database including a plurality of different identifiers; and
means for providing an alert to a user of the device if the received identifier corresponds to an identifier included in the database.

2. A device as claimed in claim 1, wherein the means for providing an alert does not provide an alert to the user if the received identifier does not correspond to an identifier included in the database.

3. A device as claimed in claim 1, wherein the means for providing an alert provides a second alert, different to the alert, if the received identifier does not correspond to an identifier included in the database.

4. A device as claimed in claim 3, wherein the database includes a first portion of data for each of the plurality of different identifiers and a second portion of data for at least one of the plurality of different identifiers, whereby the controller checks the first portion of data in response to an identifier.

5. A device as claimed in claim 4, wherein the controller checks for the presence of the second portion of data in the database and if the second portion of data is present, the controller requests the means for providing an alert to provide an alert derived from the second portion of data.

6. A device as claimed in claim 4, wherein the controller checks for the presence of the second portion of data in the database and if the second portion of data is not present, the controller provides a second alert derived from at least a part of the first portion of data.

7. A device as claimed in claim 6, wherein the second alert is derived by audio synthesis.

8. A device as claimed in claim 4, wherein the first portion of data comprises a user's name and ID data unique to the first user.

9. A device as claimed in claim 4, wherein the first portion of data comprises a telephone number associated with the first user.

10. A device as claimed in claim 4, wherein the second portion of data comprises voice data or multimedia data.

11. A device as claimed in claim 1, wherein the means for providing an alert is an audio output device.

12. A device as claimed in claim 11, wherein the alert is an audio alert from the audio output device.

13. A device as claimed in claim 11, wherein the alert is a reproduction of voice data from the audio output device.

14. A device as claimed in claim 1, wherein the device is operable to access a server which controls the environment for multi-user interaction.

15. A device as claimed in claim 14, for accessing a server which controls a second environment for multi-user interaction, wherein a further database, associated with the second environment for multi-user interaction, is stored on the server that controls the second environment for multi-user interaction.

16. A device as claimed in claim 1, wherein the environment for multi-user interaction is a software application.

17. A device as claimed in claim 1, wherein the environment for multi-user interaction is a chat room.

18. A device as claimed in claim 1, wherein the environment for multi-user interaction is a computer game.

19. A device as claimed in claim 1, wherein the device is a portable handheld radiotelephone.

20. A device as claimed in claim 1, wherein the device is a mobile game console.

21. A method for identifying when a first user enters an environment for multi-user interaction, comprising:
receiving an identifier associated with the first user;
checking the received identifier against a database including a plurality of different identifiers; and
providing an alert to a user if the received identifier corresponds to an identifier included in the database.

22. A program for a computer comprising:
means for determining that an identifier associated with the first user has been received;
means for checking the received identifier against a database including a plurality of different identifiers; and
means for requesting an alert to be provided to a user of the computer if the received identifier corresponds to an identifier included in the database.

23. A database, associated with an environment for multi-user interaction, for storing information corresponding to at least one user, the information including a plurality of different identifiers for respective users and voice data associated with at least one user.

24. A graphical user interface for displaying:
a database, associated with an environment for multi-user interaction, for storing information corresponding to at least one user, the information including a plurality of different identifiers for different users and voice data associated with at least one user, wherein the graphical user interface is responsive to an input from a user to modify the identifier or voice data associated with a user.

25. A program for a computer for providing a graphical user interface as claimed in claim 24.

26. A data carrier storing a program for a computer as claimed in claim 22.

27. A data carrier storing a program for a computer as claimed in claim 25.
